(19) United States
(12) Patent Application Publication
(10) Pub. No.: US 2013/0309572 A1
(43) Pub. Date: Nov. 21, 2013

(54) DUAL-LAYER STRUCTURED CATHOD AND ELECTROCHEMICAL CELL

(71) Applicants: Shengshui Zhang, Olney, MD (US); Jeffrey A. Read, West Friendship, MD (US)

(72) Inventors: Shengshui Zhang, Olney, MD (US); Jeffrey A. Read, West Friendship, MD (US)

(73) Assignee: U.S. Government as represented by the Secretary of the Army, Adelphi, MD (US)

(21) Appl. No.: 13/476,281

(22) Filed: May 21, 2012

(51) Int. Cl. H01M 4/583; H01M 4/40; H01M 10/04; H01M 4/62; B82Y 30/00

(52) U.S. Cl. 429/217; 429/231.8; 429/231.95; 429/231.4; 429/231.1; 977/742

(57) ABSTRACT

The present invention relates to dual-layered structured sulfur cathodes comprising (a) an electroactive layer and (b) a non-electroactive conductive layer, wherein the non-electroactive conductive layer adsorbs soluble polysulfides and provides reaction sites for the reduction of polysulfides. The present invention also relates to method of making dual-layered structured sulfur cathodes and electrochemical cells.

### CROSS-REFERENCE TO ISSUED PATENTS

Attention is directed to commonly owned and assigned U.S. Pat. No. 7,147,967, issued Dec. 12, 2006, entitled “CATHODE FOR METAL-OXYGEN BATTERY”, wherein there is disclosed a cathode material for a metal-oxygen battery such as a lithium-oxygen battery. The material comprises, on a weight basis, a first component which is an oxide or a sulfide of a metal. The first component is capable of intercalating lithium, and is present in an amount of greater than about 20 percent and to about 80 percent of the material. The material includes a second component which comprises carbon. The carbon is an electro active catalyst which is capable of reducing oxygen, and comprises from about 10 to about 80 percent of the material. The material further includes a binder, such as a fluoropolymer binder, which is present in an amount of from about 5 to about 40 weight percent.

### GOVERNMENTAL INTEREST

The invention described herein may be manufactured, used, and licensed by or for the United States Government.

U.S. Pat. No. 7,833,660, issued Nov. 16, 2010 entitled “FLUOROHALOBORATE SALTS, SYNTHESIS AND USE THEREOF”, wherein there is disclosed a composition as a salt having the formula MBF₃X where M is an alkali metal cation and X is the halide fluoride, chloride, bromide or iodide. A lithium salt has several characteristics making the composition well suited for inclusion within a lithium-ion battery. A process for forming an alkali metal trifluorohaloborate salt includes the preparation of a boron trifluoride etherate in an organic solvent. An alkali metal halide salt where the halide is fluoride, chloride, bromide or iodide is suspended in the solution and reacted with boron trifluoride etherate to form an alkali metal trifluorohaloborate. The alkali metal trifluorohaloborate so produced is collected as a solid from the solution.

The entire disclosures of each of the above mentioned patents are incorporated herein by reference in their entirety. The appropriate components and processes of these patents may be selected for the present invention in embodiments thereof.

### BACKGROUND

The present invention generally relates to an electrochemical cell. More particularly, the present invention relates to a dual-layer structured sulfur cathode that comprises (a) an electroactive layer, and (b) a non-electroactive conductive layer, wherein the non-electroactive conductive layer adsorbs soluble polysulfides and provides reaction sites for the reduction of polysulfides.

Lithium sulfur (Li/S) batteries are among the highest energy density chemistries with a theoretical specific energy of 2600 Wh/kg and a theoretical specific capacity of 1650 Ah/kg, assuming complete reduction of elemental sulfur into product Li₂S. However, the theoretical energy and capacity of sulfur are hardly achieved in practical batteries because of the high solubility of polysulfides, a series of reduction intermediates of elemental sulfur, in organic electrolytes. Dissolution of polysulfides not only loses sulfur active material but also increases the self-discharge rate of Li/S batteries. In rechargeable Li/S batteries, the dissolution of polysulfides also reduces charging efficiency because soluble polysulfides diffuse to anode side and either reduce on the anode or react directly with the lithium anode.

Despite the numerous approaches disclosed in the related art, there remains a need for an improved and practical dual layered sulfur cathodes capable of sustaining a relatively high current density.

### SUMMARY

The invention relates to batteries with dual layer cathodes.

In one aspect of the present invention relates to dual-layer structured sulfur cathodes which comprise (a) an electroactive layer, and (b) a non-electroactive conductive layer.

In another aspect, the electroactive layer comprises a sulfur-containing material that includes one or more materials selected from the group consisting of elemental sulfur and lithium polysulfide salts having a general formula of Li₂Sₓ wherein x is an integer from 2 to 12.

In other embodiments, the electroactive layer further comprises a pore-forming filler that includes one or more materials selected from the group consisting of carbon powders, carbon fibers, carbon nanotubes, carbon cloth, graphites, and non-electroactive particulate materials.

In further embodiments, the non-electroactive conductive layer comprises one or more materials selected from the group consisting of conductive carbons, active carbons, carbon fibers, carbon nanotubes, graphites, metal powders, and metal fibers.

In another embodiment, the electroactive layer and the non-electroactive conductive layer further comprise binders. The binders comprise those commonly used in the cathode of lithium batteries and lithium-ion batteries.

In still further embodiments, the non-electroactive conductive layer is laminated on the top of the electroactive layer.

Another aspect of the present invention relates to electrochemical cells which comprise an anode, a sulfur cathode of the present invention, and an electrolyte interposed between the anode and the sulfur cathode.

Examples of suitable anode materials for use in the anodes of the cells of the present invention include, but are not limited to, lithium metal, lithium alloys, lithium-intercalated carbons, and lithium-intercalated silicons.

Examples of suitable electrolytes for use in cells of the present invention include, but are not limited to, liquid electrolytes, gel polymer electrolytes, and solid polymer electrolytes.

Yet another aspect of the present invention relates to methods of manufacturing dual-layer structured sulfur cathodes, as described herein.

As one of skill in the art will appreciate, features of one embodiment and aspect of the invention are applicable to other embodiments and aspects of the invention.

### BRIEF DESCRIPTION OF THE DRAWINGS

FIG. 1 shows a dual-layer structured cathode incorporating a cathode configuration wherein the sulfur-containing electroactive layer (11) is in contact with a foil-shaped current collector (13) and the non-electroactive conductive layer (12) is laminated on the top of the sulfur-containing electroactive layer.

FIG. 2 shows a dual-layer structured cathode incorporating a cathode configuration wherein the grid-shaped current collector (23) is embedded in the sulfur-containing electroactive layer (21) and the non-electroactive conductive layer (22) is laminated on the top of the sulfur-containing electroactive layer.

FIG. 3 shows a dual-layer structured cathode incorporating a cathode configuration wherein the grid-shaped current collector (33) is embedded in the non-electroactive conductive layer (32) and is laminated on the top of the sulfur-containing electroactive layer (31).

FIG. 4 shows a plot of the cell voltage on the first discharge for two Li/S cells using the sulfur cathodes described in Example 1 with and without a dual-layer structure.

FIG. 5 shows a plot of the cell voltage on the first discharge for two Li/S cells using the sulfur cathodes described in Example 2 with and without a dual-layer structure.

FIG. 6 shows a plot of the cell voltage on the first discharge for two Li/S cells using the sulfur cathodes described in Example 3 with and without a dual-layer structure.

### DETAILED DESCRIPTION

One aspect of the present invention relates to the method of making and the use of dual-layer structured cathodes for use in electrochemical cells comprising (a) an electroactive layer, and (b) a non-electroactive conductive layer. The dual-layer structured cathodes of the present invention may be used in electrochemical cells which comprise electroactive sulfur-containing cathodes and which require high energy density.

### Electroactive Layer

In one embodiment, the electroactive layer comprises sulfur-containing cathode material comprising elemental sulfur and lithium polysulfide salts having a general formula of Li₂Sx and wherein x is an integer from 2 to 12. The amount of sulfur-containing cathode material in the electroactive layer varies by weight from about 60 percent to about 100 percent. In particular, the amount of sulfur-containing cathode material in the electroactive layer is 100 percent as long as the electroactive layer can be formed without need of other additives such as binders and pore-forming fillers. These particular examples include elemental sulfur films formed on the current collector by melt-casting or pressing.

In embodiments, the electroactive layer comprises a pore-forming filler that generates pores for the access of electrolyte. The pore-forming filler includes one or more materials selected from the group consisting of carbon powders, carbon fibers, graphites, and non-electroactive particulate materials. Examples of the non-electroactive particulate materials include, but not limited to, silicas, aluminum oxides, silicates, and titanium oxides. The amount of pore-forming filler varies by weight from about 0 percent to about 30 percent. In particular, no pore-forming filler is needed if sufficient porosity of the electroactive layer can be formed by itself of the sulfur-containing cathode material.

In embodiments, the electroactive layer comprises a binder comprising organic polymers such as polytetrafluoroethylenes (PTFE), polyvinylidene fluorides (PV dF), poly(vinylidene fluoride-co-hexafluoropropylene) copolymers, poly(ethylene oxide) (PEO), poly(acrylonitrile-methyl methacrylate) (ANMMA), ethylene-propylene-diene (EPDM) rubbers, styrene-butadiene rubber (SBR), poly(acrylamide-co-diallyldimethylammonium chloride) (AMAC), and cellulose. The amount of binder varies by weight from about 0 percent to about 10 percent. In other embodiments, no binder is needed if the electroactive layer can be formed by itself with a sulfur-containing cathode material.

### Non-Electroactive Conductive Layer

In another embodiment, the non-electroactive conductive layer adsorbs soluble polysulfides released from the electroactive layer and provides reaction sites for the reduction of polysulfides.

Sufficient porosity is required to allow the access of electrolytes, polysulfides and the reduction products of polysulfides. The non-electroactive layer comprises one or more conductive materials selected from the group consisting of conductive carbons, active carbons, carbon fibers, carbon nanotubes, carbon cloth, graphites, metal powders, metal fibers, and metal nanotubes. The amount of conductive materials varies by weight from about 80 percent to about 100 percent. In particular, the amount of conductive material in the non-electroactive layer may be 100 percent as long as the porous layer can be formed by itself. Examples include woven carbon clothing, non-woven carbon clothing, woven metal clothing, and non-woven metal clothing.

In one embodiment, the non-electroactive layer comprises a binder that includes, but not limited to, organic polymers such as polytetrafluoroethylenes (PTFE), polyvinylidene fluorides (PV dF), poly(vinylidene fluoride-co-hexafluoropropylene) copolymers, poly(ethylene oxide) (PEO), poly(acrylonitrile-methyl methacrylate) (ANMMA), ethylene-propylene-diene (EPDM) rubbers, styrene-butadiene rubber (SBR), poly(acrylamide-co-diallyldimethylammonium chloride) (AMAC), and celluloses. The amount of binder varies by weight from about 0 percent to about 20 percent. In particular, no binder is needed if the non-electroactive layer can be formed by itself. Examples include, but are not limited to, woven carbon cloth and non-woven carbon cloth.

### Dual-Layer Structured Cathodes

In one embodiment, the non-electroactive conductive layer is laminated on the top of the electroactive layer.

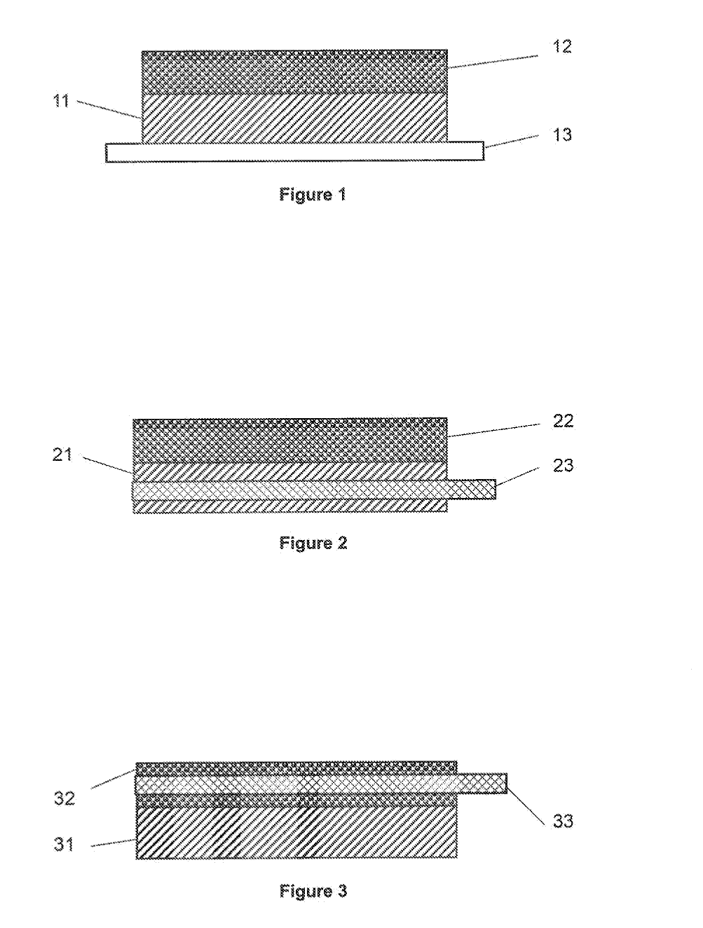

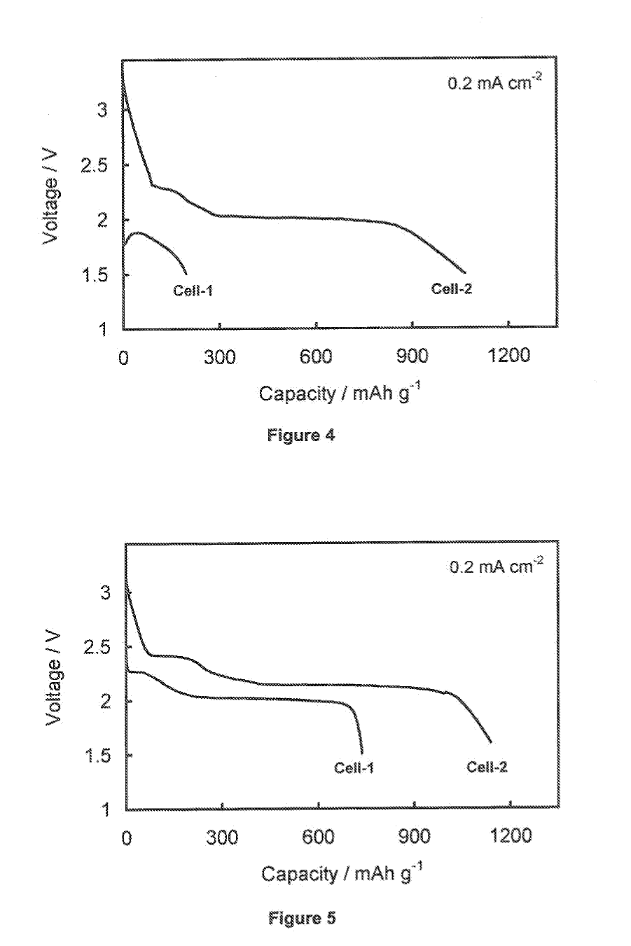

In embodiments there are three configurations for the dual-layer structured cathodes. For example, the first configuration uses a foil-shaped current collector as illustrated in FIG. 1, wherein the sulfur-containing electroactive layer (11) is in contact with the current collector (13) and the non-electroactive conductive layer (12) is laminated on the top of the sulfur-containing electroactive layer (11). The current collector (13) is in the form of metal foils; As a second example, there is a grid-shaped current collector as illustrated in FIG. 2, wherein the current collector (23) is embedded in the sulfur containing electroactive layer (21) and the non-electroactive conductive layer (22) is laminated on the top of the sulfur-containing electroactive layer (21); The third configuration uses a grid-shaped current collector as illustrated in FIG. 3, however, the current collector (33) is embedded in the non-electroactive conductive layer (32) and the non-electroactive conductive layer (32) is laminated on the top of the sulfur-containing electroactive layer (31). Examples of the metals used in current collectors (13) in FIG. 1 include, but not limited to, nickel, titanium, aluminum, copper, and stainless steel. Such metallic current collectors may optionally have a layer comprising conductive carbon or graphite coated on the metallic layer. The current collectors (23) in FIG. 2 and (33) in FIG. 3 are in any forms of metal grids, metal meshes, and metal screens.

### Methods of Making Dual-Layer Structured Cathodes

One aspect of the present invention relates to methods for manufacturing dual-layer structured cathodes, as described herein.

There are several methods available for the fabrication of dual-layer structured cathodes, for example, one embodiment uses a double slurry-coating technique, in which the sulfur-containing electroactive slurry is first coated onto the current collector and dried, then the second non-electroactive conductive layer is coated on the top of the electroactive layer.

In embodiments, the electroactive layer and the non-electroactive layer use different binders and the solvent used for one binder does not dissolve the other binder. A second embodiment uses a laminating technique, in which the electroactive layer and the non-electroactive layer are fabricated individually by rolling the component material paste into sheets, and then the two sheets are laminated together. In another embodiment the two techniques of slurry-coating and paste-rolling are combined, in which the electroactive layer is coated onto the current collector and the non-electroactive conductive material is rolled as a separate sheet followed by laminating it on the top of electroactive layer. In a further embodiment, the electroactive layer, for example, also can be fabricated by casting the melt of sulfur-containing materials onto the current collector.

### Electrochemical Cells Using the Dual-Layer Structured Cathodes

In aspects, the present invention relates to electrochemical cells comprising: (a) an anode, (b) a cathode, and (c) an electrolyte interposed between the anode and the cathode, wherein the non-electroactive conductive layer of the dual-layer structured cathode is in contact with the electrolyte or a separator.

Suitable anode active materials for the electrochemical cells of the present invention comprise one or more metals or metal alloys or a mixture of one or more metals and one or more alloys, wherein said metals are comprised of the Group IA and IIA metals in the Periodic Table. Examples of suitable anode active materials comprise lithium metal, lithium alloys, lithium-intercalated carbons, and lithium-intercalated silicons.

The electrolytes used in cells function as a medium for the transport of ions and, in the case, for example, of solid electrolytes, these materials may additionally function as separator materials between the anode and the cathode. Examples of suitable electrolytes for use in the present invention comprise, organic electrolytes comprising one or more materials selected from the group consisting of liquid electrolytes, gel polymer electrolytes, and solid polymer electrolytes.

Liquid electrolytes comprise electrolyte solvents and electrolyte salts. Examples of electrolyte solvents comprise the linear or cyclic ethers such as dimethyl ether, diethyl ether, methylethyl ether, glymes, dioxolanes, dioxane, tetrahydrofuran; the linear or cyclic carbonates and carboxylic esters, for example ethylene carbonate, propylene carbonate, dimethyl carbonate, diethyl carbonate, ethylmethyl carbonate, y-butyrolactone, methyl butyrate, ethyl butyrate; N-methyl acetamide, N-alkyl pyrrolidones; the linear or cyclic organic sulfones and sulfites such as tetramethylene sulfone, ethylene sulfite, ethylmethyl sulfone; the linear or cyclic nitriles such as acetonitrile, ethoxypropionitrile; and substituted forms of the foregoing, and mixtures thereof.

Examples of electrolyte salts include, but are not limited to, MBr, MNO₃, MNO₂, MC1O₄, MPF₆, MAsF₆, MBF₄; MBF₃X (X═Cl or Br), MB(C₂O₄)2, MB(C₂O₄)F₂, MSO₃CF₃, MN(SO₂CF₃)₂, MN(SO₂CF₃CF₃)₂, and the like, where M is Li or Na.

Gel polymer electrolytes comprise one or more polymers and one or more liquid plasticizers.

The liquid electrolytes are themselves useful as plasticizers. Examples of polymers for gel polymer electrolytes comprise poly(ethylene oxide) (PEO), poly(propylene oxide) (PPO), polyacrylonitrile (PAN), polyvinylidene fluoride (PV dF), poly(vinylidene fluoride-co-hexafluoropropylene) copolymers, poly(acrylonitrile-methyl methacrylate) copolymers, and polyimides.

Examples of solid polymer electrolytes comprise poly(ethylene oxide) (PEO), poly(propylene oxide) (PPO), polyphosphazene, polysiloxane, derivatives of the foregoing, copolymers of the foregoing, and blends of the foregoing; to which is added an appropriate electrolyte salt.

### EXAMPLES

Several embodiments of the present invention are described in the following examples, which are offered by way of illustration and not by way of limitation.

### Example 1

A sulfur cathode was prepared as follows: A slurry was prepared by mixing elemental sulfur with an about 5 percent by weight poly(acrylonitrile-methyl methacrylate) (ANMMA) solution in Nmethylpyrrolidone (NMP) in a solid weight ratio of about 90 to about 10. The mixture was ball-milled for 8 hours to obtain homogenous slurry and then the slurry was cast by hand coating using a gap coater bar onto a carbon-coated aluminum foil as a current collector and dried in an oven at about eighty (80) degrees Celsius for 1 hour. The resulting coating has a sulfur loading of about 6.5 mg/cm².

A carbon conductive sheet was prepared as follows: activated carbon was wetted using alcohol, and then an emulsion of polytetrafluoroethylene (PTFE) (having a solid content of about 61.5 percent) was added in a solid weight ratio of about 92 to about 8 and mixed completely. The obtained paste was rolled into a sheet and dried at about 100° C. for about 1 hour. The resulting carbon sheet contained a carbon loading of 11 mg/cm². The dual-layer structured sulfur cathode was made by laminating the conductive carbon sheet onto the sulfur cathode.

With an electrolyte solution of 0.5 M LiSO₃CF₃ dissolved in a 1:1 by weight mixture of dimethyl ether (DME) and 1,3-dioxolane (DOL), two coin Li/S cells having a cathode area of about 1.27 cm² were assembled using the single-layer sulfur cathode and the dual-layer structured cathode made above, separately, and discharged at 0.2 mA/cm² until the cell voltage declined to about 1.5 V. As indicated in FIG. 1, Cell-1 using the single-layer sulfur cathode showed only about a 197 mAh/g capacity and had much lower discharge voltage. Whereas Cell-2 using the dual-layer structured sulfur cathode gave about a 1064 mAh/g capacity and higher discharge voltage. After discharging, the cells were disassembled, showing that the color of electrolyte in Cell-1 became dark-brown (being the color of polysulfide) while the color of electrolyte in Cell-2 still remained colorless. This example indicates that the dual-layer structured cathode effectively retarded the diffusion of polysulfides from the cathode to the electrolyte.

### Example 2

Following the procedure described in Example 1, a single-layer sulfur cathode with a composition by weight of about 77 percent elemental sulfur, 10 percent Ketjenblack carbon, and 3 percent ANAM binder was prepared. The resulting coating had a sulfur loading of about 3.3 mg/cm². The dual-layer structured sulfur cathode was made using the same carbon conductive sheet and the procedure as described in Example 1.

Two Li/S coin cells with the single-layer sulfur cathode and the dual-layer structured sulfur cathode, respectively, were assembled and discharged by using the same electrolyte and discharging condition as described in Example 1. FIG. 5 compares the voltage curves of the first discharge of these two cells. As indicated in FIG. 5, Cell-1 using the single-layer sulfur cathode had a 737 mAh/g capacity and Cell-2 using the dual-layer structured sulfur cathode not only gave higher capacity (1339 mAh/g), but also showed higher discharge voltages. After discharging, the cells were disassembled, showing that the color of electrolyte in Cell-1 became brown (the color of polysulfide) while the color of electrolyte in Cell-2 still remained colorless. This example indicates that the dual-layer structured cathode effectively retarded the diffusion of the polysulfides from the cathode to the electrolyte.

### Example 3

A free-standing and flexible sulfur sheet was made as follows: Calculated amounts of elemental sulfur and activated carbon were mixed homogeneously, the resulting mixture was wetted using alcohol, and then an emulsion of polytetrafluoroethylene (PTFE) (having a solid content of about 61.5 percent) was added and mixed to form a paste. The obtained paste was rolled into a sheet and dried at about 80° C. for about 1 hour to form a free-standing and flexible sulfur sheet that had a composition by weight of about 70 percent Sulfur, 28 percent Super-P carbon, and 2 percent PTFE, and a sulfur loading of 6 mg/cm².

A dual-layer structured sulfur cathode was prepared by laminating the carbon conductive sheet prepared as described in Example 1 onto the sulfur sheet. Using the single-layer sulfur cathode and dual-layer sulfur cathode made above, respectively, two Li/S coin cells were assembled and discharged by using the same electrolyte and discharging condition as described in Example 1.

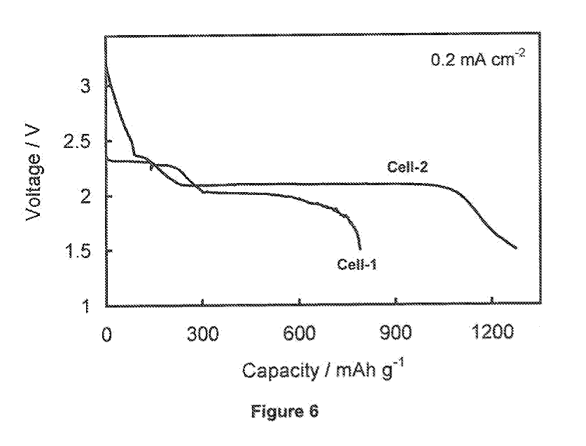

FIG. 6 compares the voltage curves of the first discharge of these two cells. As indicated in FIG. 6, Cell-1 using the single-layer sulfur cathode had a 790 mAh/g capacity, whereas Cell-2 using the dual-layer structured sulfur cathode gave a 1274 mAh/g capacity. After discharging, the cells were disassembled, showing that the color of electrolyte in Cell-1 became brown (the color of polysulfide) while the color of electrolyte in Cell-2 still remained colorless. This example indicates that the dual-layer structured cathode effectively retarded the diffusion of polysulfides from the cathode to electrolyte.

### Example 4

Three Li/S coin cells with the following configurations were assembled using the same electrolyte as described in Example 1.

Cell-1 used a single-layer sulfur cathode having a composition by weight of about 90 percent elemental sulfur and about 10 percent ANMMA binder as described in Example 1. Cell-2 had the following configuration: (+) Sulfur cathode-Separator-Carbon conductive sheet/Separator/-Li (−), wherein the sulfur cathode and carbon conductive sheet were physically isolated by a separator.

Cell-3 had the same configuration as Cell-2, however, the edges of carbon conductive sheet were intentionally connected to the current collector. In this cell embodiment, the sulfur cathode and carbon conductive sheet were physically isolated by a separator, however, they got electrical circuit-shortening with each other.

Three cells were discharged under the same conditions as described in Example I, which resulted in capacities of 197, 215, and 864 mAh/g for Cell-1, Cell-2 and Cell-3, respectively.

After discharging, the cells were disassembled, showing that the color of electrolyte in Cell-I became brown (the color of polysulfide) while the color of electrolytes in Cell-2 and Cell 3 still remained colorless. This experiment indicates that the functions of the porous nonelectroactive conductive layer not only adsorb soluble polysulfides but also provide reaction sites for the reduction of polysulfides.

What is claimed is:

1. A dual-layer structured sulfur cathode for use in electrochemical cells comprising:
a) (i) an electroactive layer and (ii) a non-electroactive conductive layer;
b) wherein the electroactive layer comprises a sulfur-containing material further comprising one or more materials selected from the group consisting of elemental sulfur and lithium polysulfide salts having a general formula of Li₂S_{x:}
c) wherein X is an integer from 2 to 12;
d) wherein said sulfur-containing material has a weight percent of from about 60 to about 100 percent;
e) further wherein the electroactive layer comprises a pore-forming filler selected from the group consisting of carbon powders, carbon fibers, carbon nanotubes, graphites, and non-electroactive particulate materials and wherein said pore-forming filler has a weight percent of from about 0 to about 30 percent; and
f) still further wherein said non-electroactive conductive layer adsorbs dissolved polysulfides and provides reaction sites for polysulfide reduction and effectively retards the crossover of polysulfides from the cathode to the anode.

2. The cathode of claim 1, wherein the electroactive layer further comprises a binder having from about 0 to about 10 percent by weight.

3. The electroactive layer according to claim 2, wherein the binder is selected from the group consisting of polytetrafluoroethylenes (PTFE), polyvinylidene fluorides (PV dF), poly(vinylidene fluoride-co-hexafluoropropylene) copolymers, poly(ethylene oxide) (PEO), poly(acrylonitrile-methyl methacrylate) (ANMMA), ethylene-propylene-diene (EPDM) rubbers, styrene-butadiene rubber (SBR), poly(acrylamide-co-diallyldimethylammonium chloride) (AMAC), and celluloses.

4. The cathode of claim 1, wherein the non-electroactive conductive layer comprises one or more materials selected from the group consisting of conductive carbons, active carbons, carbon fibers, carbon cloth, graphites, metal powders, and metal fibers having from about 80 to about 100 percent by weight.

5. The cathode of claim 1, wherein the non-electroactive conductive layer further comprises a binder having from about 0 to about 20 percent by weight.

6. The non-electroactive layer according to claim 5, wherein the binder is selected from the group consisting of polytetrafluoroethylenes (PTFE), polyvinylidene fluorides (PV dF), poly(vinylidene fluoride-co-hexafluoropropylene) copolymers, poly(ethylene oxide) (PEO), polyacrylonitrile-methyl methacrylate) (ANMMA), ethylene-propylene-diene (EPDM) rubbers, styrene-butadiene rubber (SBR), poly(acrylamide-co-diallyldimethylammonium chloride) (AMAC), and celluloses.

7. The cathode of claim 1, wherein the non-electroactive conductive layer is laminated on the top of the electroactive layer.

8. A cathode according to claim 1, wherein the lithium polysufide salt is Li₂S₂.

9. A cathode according to claim 1, wherein the lithium polysufide salt is Li₂S₄.

10. A cathode according to claim 1, wherein the lithium polysufide salt is Li₂S₆.

11. A cathode according to claim 1, wherein the lithium polysufide salt is Li₂S₈.

12. A cathode according to claim 1, wherein the lithium polysufide salt is Li₂S₁₀.

13. A cathode according to claim 1, wherein the lithium polysufide salt is Li₂S₁₂.

14. An electrochemical cell comprising:
a) an anode;
b) a cathode described in claim 1; and
c) an electrolyte interposed between the anode and the cathode.

15. The cell of claim 14, wherein the anode comprises one or more anode active materials selected from the group consisting of lithium metal, lithium alloys, lithium-intercalated carbons, and lithium-intercalated silicons.

16. The cell of claim 14, wherein the electrolyte comprises one or more materials selected from the group consisting of liquid electrolytes, gel polymer electrolytes, and solid polymer electrolytes.
